(19) United States
(12) Patent Application Publication
(10) Pub. No.: US 2009/0014036 A1
(43) Pub. Date: Jan. 15, 2009

(54) CLEARING PIPEWORK IN OIL REFINERIES AND OTHER PLANT HAVING EXTENSIVE PIPEWORK

(75) Inventor: Keith Roscoe, Cheshire (GB)

Correspondence Address: BARLOW, JOSEPHS & HOLMES, LTD., 101 DYER STREET, 5TH FLOOR, PROVIDENCE, RI, 02903, US

(73) Assignee: WHIRLWIND BY-AIR LIMITED, Cheshire (GB)

(21) Appl. No.: 11/568,739

(22) PCT Filed: May 5, 2004
(86) PCT No.: PCT/GB2004/001917

§ 371 Date: Sep. 29, 2008

(51) Int. Cl. B08B 9/027

(52) U.S. Cl. 134/22.15

(57) ABSTRACT

A method for clearing pipework in an oil refinery includes the steps of: blowing, using a first, low velocity gas flow, pipe contents out of the pipework in such fashion that the contents are removed using gas overpressure, to leave a low contents residue; and substantially clearing the residue by a second, high velocity gas flow, the gas flows being such as not to give rise to a hazardous reaction such as fire or explosion. Apparatus for the same includes gas blowing means connectable to the pipework; valving adapted to throttle down an outlet of the pipework, said blowing means and valving being adapted to cooperate to effect both low velocity flow and high velocity flow through the pipework; and gas supply means to the blowing means supplying a gas that will not give rise to a hazardous reaction such as fire or explosion.

This invention relates to clearing pipework in oil refineries and other plant having extensive pipework.

It is necessary periodically to clear oil and oil products from pipework in oil refineries for routine maintenance operations, and, of course, when a refinery section is in need of repair. Conventionally, such pipework is cleared of oil or oil products by high pressure superheated steam jetted into the pipework. This is claimed to clear up to 85% of product from the pipework, the residue being removed by solvent flushed through the pipework, the solvent being eventually removed by a nitrogen flush.

This is a time-consuming operation, taking perhaps several days to a week to fully clear the pipework. During this time, the section of the plant is out of action, resulting in very expensive loss of production. Moreover, any product flushed out of the pipe is contaminated by condensed steam and unusable, and needs to be disposed of or expensively recovered. The whole operation is expensive and involves eco-unfriendly use of solvents and energy.

The present invention provides a method for clearing pipework in oil refineries that is not subject to these disadvantage, that uses no, or comparatively tiny amounts of solvent, has low energy requirements, yet can be carried out in a fraction of the time taken by the conventional process. Typically, a pipe section in a refinery can be cleared, using the method and apparatus of the invention, and rehabilitated for use in half a day, resulting in substantial cost savings. An operation of this nature is, on average, carried out some fifty times every year in a typical refinery.

The method is adaptable for clearing pipework in other plant having extensive pipework

The invention is a development of the general method disclosed in WO 01/17700.

The invention comprises a method for clearing pipework in an oil refinery or other plant having extensive pipework comprising the steps of:
blowing, using a first, low velocity, gas flow, pipe contents out of the pipework in such fashion that the contents are removed using gas overpressure, to leave a low contents residue; and
substantially clearing the residue by a second, high velocity gas flow;
the gas flows being such as not to give rise to a hazardous reaction such as fire or explosion.

The gas flows may be of the same gas or of different gases. At least one gas flow may be of superheated steam. At least one gas flow may be of nitrogen.

The first gas flow may be such as to apply a pressure of the order of 1 bar against the pipe contents. If the gas is superheated steam, of course, the pressure in the pipe will be some 25 bar, in order to maintain the steam superheated.

The gas flow may be generated at its operating pressure by a blower. A blower to generate a superheated steam flow may be contained within a pressure vessel which can be filled with superheated steam.

The pipework to be cleared may be maintained at a desired pressure by controlling valving at the outlet and/or by controlling the supply of the first gas flow. Such control may be effected using a feed back arrangement.

The second, high speed gas flow may have a velocity of the order of 20 m/s

The gas used for the second gas flow may be the same as or different from that used for the first gas flow. If it is the same, it may be generated by the same means or by different means.

The method may involve a washing step, in which a liquid washing medium is introduced into the pipework after the second gas flow step. The washing medium may comprise a solvent for any residual product in the pipework, and may be water, to which a surfactant may be added, or an organic solvent, for instance.

The washing medium may be expelled from the pipework in similar fashion to the product, namely by a first low velocity gas flow followed by a second, high velocity gas flow. The pipework may then be dried by adiabatic heating, namely by throttling back outlet valving and blowing air into the pipework to increase the pressure.

Remaining traces of product and/or solvent left in the surface texture of the pipework may be removed by high speed gas scrubbing.

The invention also comprises apparatus for clearing pipework in oil refineries and like plant with extensive pipework, comprising:
gas blowing means connectable to the pipework;
valving adapted to throttle down an outlet of the pipework;
said blowing means and valving being adapted to cooperate to effect both low velocity flow and high velocity flow through the pipework; and
gas supply means to the blowing means supplying a gas that will not give rise to a hazardous reaction such as fire or explosion.

The gas blowing means may comprise a pump, turbine, compressor or other means capable of generating a gas flow velocity along oil refinery or like pipework of the order of 20 m/s.

The gas supply means may comprise a supply of superheated steam and/or a supply of nitrogen.

For superheated steam, the blower means may be contained within a pressure chamber supplied with superheated steam (from an internal or an external steam generator). The blower may comprise a rotary fan on a shaft, which extends through bearing means with a pressure sealing arrangement in the pressure chamber wall, to be driven by an external motor.

The gas blowing means and valving may be further adapted to cooperate to elevate the pressure inside the pipework adiabatically so as to increase the temperature of the gas therein to evaporate any washing liquid that may have been used to clean the pipework after clearing the contents.

The apparatus may comprise a control arrangement controlling the gas blowing means, and may comprise sensors for pressure, temperature and/or other variables inside the pipework. The control arrangement may be adapted to detect when a low velocity flow should terminate and a high velocity flow begin and effect the transition between the two flows, as well as control any washing liquid input and purging with adiabatic heating, so that a pipe clearing operation can take place completely automatically.

While apparatus as described can be installed at each and every location in an oil refinery at which pipe clearing is required, it should suffice to have two or three mobile units engaged on routine maintenance and/or emergency repair work. The units would be on trucks or trailers movable about the refinery and attachable to porting in pipework as required. The invention also comprises apparatus for clearing pipework for maintenance or repair work in an oil refinery comprising one or more mobile units comprising apparatus as outlined above adapted to connect with locations in refinery pipework.

Methods and apparatus for clearing pipework in oil refineries will now be described with reference to the accompanying drawings, in which:

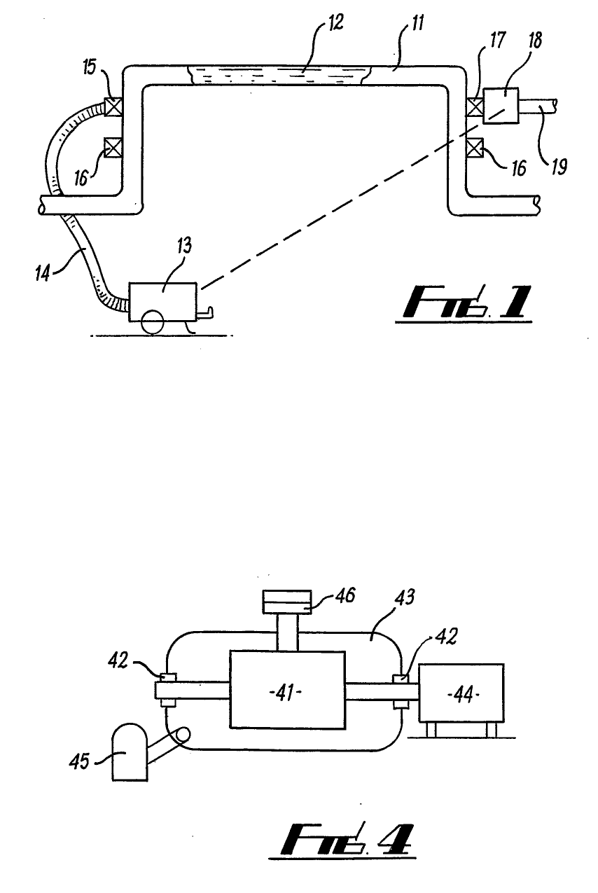

FIG. 1 is a view of an oil refinery location at which a mobile apparatus unit is connected to clear pipework;

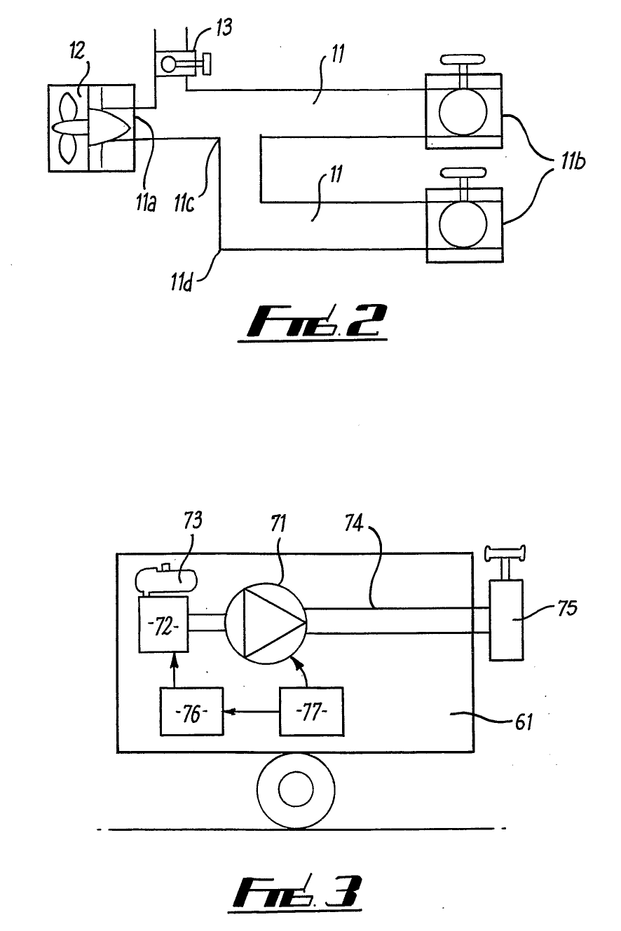

FIG. 2 is a diagrammatic illustration of a basic system of operation;

FIG. 3 is a diagrammatic illustration of a trailer unit;

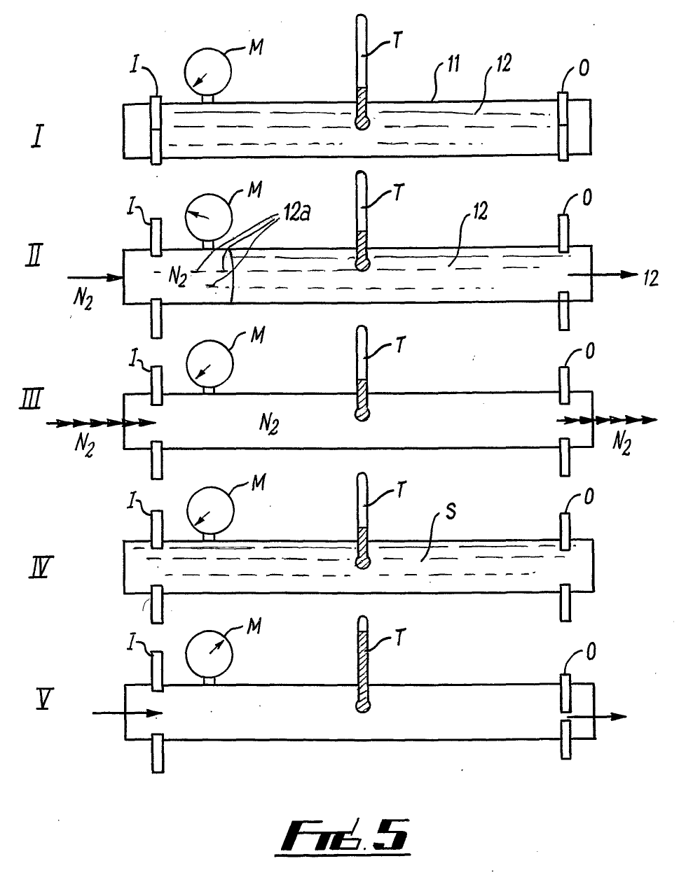

FIG. 4 is a diagrammatic illustration of a trailer unit adapted for superheated steam blowing; and

FIG. 5 is a series of depictions of a pipe at different stages of clearing.

The drawings illustrate a method for clearing pipework 11 in an oil refinery comprising the steps of:
blowing, using a first, low velocity, gas flow, pipe contents 12 out of the pipework 11 in such fashion that the contents are removed using gas overpressure, to leave a low contents residue; and
substantially clearing the residue by a second, high velocity gas flow;
the gas flows being such as not to give rise to a hazardous reaction such as fire or explosion.

Gases that can be used include superheated steam, which is already used for pipe clearing in oil refineries, though in a different way, and nitrogen, which is also used in refineries and is in copious supply, there being usually a nitrogen production plant nearby or actually on the site. While the two gas flows could be of different gases, it will usually be convenient to use the same gas for the two flows, though superheated steam could be used first, then nitrogen second.

FIG. 1 illustrates a trailer 13 connected by flexible hose 14 to the pipework 11 by a valve 15. Isolator valves 16 on the pipework 11 can be used to seal off the section of pipe to be cleared. The trailer 13 houses a blower and a prime mover, such as a diesel engine, as well as control equipment. A valve 17 is fitted with a control valve arrangement 18, under the control (as indicated by the broken line) of the equipment in the trailer 13, to open, close or throttle down the valve 17 as required during the various stages of the clearing operation. Outlet 19 can be connected to whatever vessel or ducting the pipe contents are to be delivered to.

Whichever gas is used for the first flow, it is delivered into the pipe to be cleared in such a fashion that it effectively pushes the pipe contents out as a plug. Even for quite viscous pipe contents, surprisingly little overpressure is required. Using nitrogen, for example, an overpressure of 1 bar is sufficient to push the pipe contents out through an outlet. The flow rate will be quite low, perhaps—depending on the viscosity and density of the pipe contents and the pipe dimensions—about 1 m/s or less. Reference may be had to FIG. 5, where Stage I shows a pipe 11 full of, say, crude oil 12. Inlet and outlet valves, I, O, respectively, are, at this stage, closed. Stage II shows nitrogen gas at a pressure of 2 bar, i.e. 1 bar over atmospheric, pushing out the crude through outlet O. This operation serves usually to remove well over 90% of the pipe contents, typically, 98-99%, depending on the nature—viscosity and density—of the pipe contents, leaving only small quantities 12a attached to the pipe wall. This residue is substantially all removed at Stage III, where gas is blown at high velocity, for example about 20 m/s, through the pipe 11.

Control of the gas flow is effected by control of blower means creating the gas flow and valving at the pipe outlet. When superheated steam is used, of course, pressure must be maintained in the pipe 11 to keep the steam superheated, so the pressure will be some 25 bar, but the pressure differential blowing the contents out of the pipe will still be only about 1 bar.

This effectively illustrates the difference between the conventional method for superheated steam clearing of pipes and the method according to the invention. In the conventional approach, superheated steam is jetted into the pipe without any attempt to maintain pressure in the pipe to keep the steam superheated. Accordingly, the steam tunnels through the contents and condenses into water, which contaminates the contents of the pipe. Although it is claimed that some 85% of contents are removed in this way, that still leaves 15% to be removed in another way, and in any event, the steam process, as conventionally practised, is time consuming and uses considerable quantities of steam. This is, at time of filing the patent application of which this is the specification, still the standard method of clearing pipework in oil refineries, despite the publication of WO 01/17700, and indeed it is by no means obvious that the general method disclosed in WO 01/17700 would be effective in any of the situations found in refineries because of the diverse, but usually flammable, nature of the products there dealt with and overall, because of the sheer mileage of pipework involved. However, the measures herein disclosed have been established to be a very considerable improvement over the conventional methods used in refineries, not least in the reduction of downtime, which, in a refinery environment, is very expensive, and all at a modest capital cost. Even quite long pipes can be substantially cleared in a few minutes using the method of the invention—a typical speed of clearance is 1 metre of pipe per second—and downtime can be reduced to a fraction, typically one tenth or less, of the conventional downtime.

At Stage IV of FIG. 5, a solvent S is passed into the pipe 11 to dissolve, if necessary, any oil film adhering to the surface. The solvent can be removed by treating it simply as a new product in the pipe, by using the low speed and high speed airflows again. Should it then be necessary to dry the pipe, evaporating any solvent left adhering to the walls, gas—which, if the first airflow was of steam, could well now be nitrogen, or even air—is introduced and compressed adiabatically, by throttling down the outlet valve O, which raises the gas temperature sufficiently to evaporate any solvent, which passes out with the gas through the throttled down valve O. Even this may not eliminate all traces of oil and/or solvent from the pipe, as some may remain within the surface texture of the pipe wall. Now, however, air can be blasted at high speed once again though the pipe as the most effective was of clearing these last stubborn traces.

The valve O can be automatically controlled either to throttle down the outlet or to allow unrestricted flow, whichever is appropriate to the particular stage of the operation being carried out. This can also be a relief valve to prevent the build up of unsafe internal pressures. Manometer M and thermometer T indicate pressures and temperatures at the various stages. At Stages I, the pressure indicated by the manometer is 1 bar, at Stage II, 2 bars, at Stages III and IV, back to 1 bar, and in Stage V, several bars, depending on the temperature rise required to evaporate the solvent in use. Temperatures in Stages I-IV are ambient, while in Stage V, the temperature is whatever is required to evaporate the solvent. Of course, the instrumentation is best realised as sensors in the pipe 11, or at the valving I and/or O, connected to control equipment controlling the blower and valving.

Data processing equipment controlling the blower and valving can evaluate, from the pressures and temperatures, as well as the flow rate, which can be sensed by a suitable instrument, the conditions in the pipe 11 so as to determine when any one stage is finished and the next should begin, all of which can be effected automatically. It is also possible to determine, from information supplied by this instrumentation, the condition of the pipe itself, namely whether it has any leaks, and, if so, their locations.

The process can clear pipework of liquids of any viscosity, even over long lengths of pipe, say, tens or even hundreds of metres. The pipework in refineries is usually 16 inch (40.6 cm) and of circular cross section, but the process can clear pipework of any size and cross-sectional shape. Nor need the pipework be of uniform cross-section—the process can clear pipework with stepped sections and complex bends. Moreover, pipework tends over time to build up hard solid deposits, which simply cannot be cleared by any conventional method except pigging. The present method, however, has successfully cleared such deposits, even when, for test purposes, rammed in tight. Solids in suspension are cleared, when other methods would leave them lying in U-bends in the pipework.

FIG. 2 illustrates diagrammatically a basic apparatus comprising a blower 12 attached at the inlet end of the pipe 11, shown here as having two outlets 11a, 11b, each provided with control valving. Here, too, a separate relief valve 13 is provided at the blower end. This may also provide access for introducing solvent or other washing liquid.

FIG. 3 illustrates a portable unit housing a blower 71 driven by a motor, such as a diesel engine 72 with a fuel tank 73. Control panels 76, 77 are provided for the prime mover 72 and the timing and valve control arrangements respectively. Panel 77 can comprise a programmable controller fed with information on conditions in the pipe by appropriately located sensors. A valved connector 74 is provided on an outlet pipe 74 from the blower 71, which can be connected by flexible tubing to inlet porting on the refinery pipework.

Refineries, as mentioned above, tend to use 16 inch (40.6 cm) piping as standard. This is usually fitted with 1 inch (2.54 cm) porting. It is more appropriate to the method of the invention to have larger diameter porting, say 2 inch (5 cm), and it would be recommended to fit the larger diameter porting at the first instance the apparatus is used, which would require little extra downtime, enabling the pipe section to be cleared in much less time, still, than for a conventional operation.

FIG. 4 illustrates how a blower could be adapted for use with superheated steam. The blower 41 is held on a shaft which is supported on bearings 42 in the walls of a pressure vessel 43 and driven in rotation by an external motor 44. Superheated steam from a generator 45 is fed into the pressure vessel 43 and blown out through delivery porting 46, to which, in use, the hose 14 of FIG. 1 would be connected.

The methods and equipment herein described can, of course, be adapted to clearing pipework in all installations having extensive pipework, such, for example, as chemical process plants, water treatment plants and power stations.

1. A method for clearing pipework in an oil refinery comprising the steps of:
blowing, using a first, low velocity, gas flow, pipe contents out of the pipework in such fashion that the contents are removed using gas overpressure, to leave a low contents residue; and
substantially clearing the residue by a second, high velocity gas flow; the gas flows being such as not to give rise to a hazardous reaction such as fire or explosion.

2. A method according to claim 1, in which the gas flows are of the same gas.

3. A method according to claim 1, in which the gas flows are of different gases.

4. A method according to claim 1, in which at least one gas flow is of superheated steam.

5. A method according to claim 1, in which at least one gas flow is of nitrogen.

6. A method according to claim 1, in which the first gas flow is such as to apply a pressure of the order of 1 bar against the pipe contents.

7. A method according to claim 6, in which the gas is superheated steam and the pressure in the pipe is such as to maintain the steam superheated.

8. A method according to claim 7, in which the pressure in the pipe is of the order of 25 bar.

9. A method according to claim 1, in which the gas flow is generated at its operating pressure by a blower.

10. A method according to claim 1, in which a blower to generate a superheated steam flow is contained within a pressure vessel which can be filled with superheated steam.

11. A method according to claim 1, in which the pipework to be cleared is maintained at a desired pressure by controlling valving at the outlet end and/or by controlling the supply of the first gas flow.

12. A method according to claim 11, in which the control is effected using a feed back arrangement.

13. A method according to claim 1, in which the second gas flow has a velocity of the order of 20 m/s.

14. A method according to claim 1, in which the second gas flow is generated by the same means as the first gas flow.

15. A method according to claim 1, in which the second gas flow is generated by different means from those used to generate the first gas flow.

16. A method according to claim 1, comprising a washing step, in which a liquid washing medium is introduced into the pipework after the second gas flow step.

17. A method according to claim 16, in which the washing medium comprises a solvent for any residual product in the pipework.

18. A method according to claim 17, in which the washing medium comprises water.

19. A method according to claim 18, in which a surfactant is added to the water.

20. A method according to claim 17, in which the washing medium comprises an organic solvent.

21. A method according to claim 1, in which the washing medium is expelled from the pipework in similar fashion to the product, namely by a first, low velocity gas flow followed by a second, high velocity gas flow.

22. A method according to claim 1, in which the pipework is dried by adiabatic heating.

23. A method according to claim 1, in which traces of product and/or solvent left in the pipework after other process steps are removed by high speed gas scrubbing.

24. Apparatus for clearing pipework in oil refineries, comprising:
gas blowing means connectable to the pipework;
valving adapted to throttle down an outlet of the pipework,
said blowing means and valving being adapted to cooperate to effect both low velocity flow and high velocity flow through the pipework; and
gas supply means to the blowing means supplying a gas that will not give rise to a hazardous reaction such as fire or explosion.

25. Apparatus according to claim 24, in which the gas blowing means comprise a pump.

26. Apparatus according to claim 24, in which the gas blowing means comprise a turbine.

27. Apparatus according to claim 24, in which the gas blowing means comprise a compressor.

28. Apparatus according to claim 24, in which the gas blowing means are capable of generating a gas flow velocity along oil refinery pipework of the order of 20 m/s.

29. Apparatus according to claim 24, in which the gas supply comprises a supply of superheated steam.

30. Apparatus according to claim 24, in which the gas supply comprises a supply of nitrogen.

31. Apparatus according to claim 24, comprising blower means contained within a pressure chamber adapted to be supplied with superheated steam.

32. Apparatus according to claim 31, in which the blower comprises a rotary fan on a shaft which extends through bearing means with a pressure sealing arrangement in the pressure chamber wall, adapted to be driven by an external motor.

33. Apparatus according to claim 24, in which the gas blowing means and valving are adapted to cooperate to elevate the pressure inside the pipework adiabatically so as to increase the temperature of the gas therein to evaporate any washing liquid that may be used to clean the pipework after clearing the contents.

34. Apparatus according to claim 24, comprising a control arrangement controlling the gas blowing means.

35. Apparatus according to claim 34, comprising sensors for pressure, temperature and/or other variables inside the pipework.

36. Apparatus according to claim 34, adapted to detect when a low velocity flow should terminate and a high velocity flow begin.

37. Apparatus according to claim 36, adapted to effect the transition between the two flows, as well as control any washing liquid input and purging with adiabatic heating, so that a pipe clearing operation can be effected completely automatically.

38. Apparatus according to claim 24, adapted to be moved around a refinery to locations requiring pipe clearing.

39. Apparatus according to claim 38, mounted on a trailer or in a van.

40. (canceled)
